(19) United States
(12) Patent Application Publication
(10) Pub. No.: US 2007/0186026 A1
(43) Pub. Date: Aug. 9, 2007

(54) System having bus architecture for improving CPU performance and method thereof

(75) Inventor: Kyoung-Hwan Kwon, Seoul (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/583,254

(22) Filed: Oct. 19, 2006

(30) Foreign Application Priority Data
Feb. 7, 2006 (KR) 10-2006-0011501

(51) Int. Cl. G06F 13/36

(52) U.S. Cl. 710/309

(57) ABSTRACT

A system and method for improving the performance of a central processing unit (CPU), in which the system includes a first master such as a CPU, a first local bus connected to a memory device, a bridge, and a main bus connected to a second master and a peripheral device. The bridge is connected among the first master, the memory device, and the main bus and functions as a wrapper and also serves to decode an address output from the first master, monitor a status of ownership of the main bus, and output a wait signal to the first master based on a decoding result and a monitoring result. Accordingly, even while the second master is accessing the peripheral device via the main bus, the first master can access the memory device via the first local bus. The memory device includes a memory core storing predetermined data and a controller having an arbitration function.

### CROSS-REFERENCE TO RELATED PATENT APPLICATION

This application claims priority under 35 U.S.C. §119 from Korean Patent Application No. 10-2006-0011501 filed on Feb. 7, 2006, the disclosure of which is hereby incorporated by reference herein as if set forth in its entirety.

### BACKGROUND OF THE INVENTION

1. Technical Field

The present disclosure relates to a method and system for improving performance of a central processing unit (CPU), and more particularly, to a method and system for optimizing CPU performance even while a master like a direct memory access unit (DMA) has ownership of a main bus.

2. Discussion of the Related Art

Micro control unit (MCU) systems including a flash memory device can perform 1-cycle code access in the flash memory device and, therefore, a central processing unit (CPU) does not include a cache or cache memory.

FIG. 1 is a block diagram of a conventional MCU system 100 including a flash memory device 103. Referring to FIG. 1, the MCU system 100 includes a CPU 101, the flash memory device 103, a static random access memory (SRAM) device 105, a direct memory access (DMA) 109, a peripheral device 111, and an arbiter 113, which are connected to a main bus 107.

While the DMA 109 has ownership of the main bus 107 through the arbitration of the arbiter 113, the CPU 101 is kept in a hold state. Only after the DMA 109 loses the ownership of the main bus 107, can the CPU 101 access the flash memory device 103 or the SRAM device 105 via the main bus 107. In addition, while the DMA 109 transmits data to and receives data from the peripheral device 111 via the main bus 107, the CPU 101 that does not have a cache or cache memory is kept in the hold state until the DMA 109 loses the ownership of the main bus 107.

In other words, while the DMA 109 accesses the peripheral device 111 via the main bus 107, the CPU 101 is kept in the hold state until the DMA 109 loses the ownership of the main bus 107 even though the DMA 109 is not accessing the flash memory device 103 or the SRAM device 105.

Such unnecessary hold of the CPU 101 decreases the performance of the MCU system 100.

### SUMMARY OF THE INVENTION

Exemplary embodiments of the present invention provide a method and system for optimizing the performance of a master like a central processing unit (CPU) while a master like a direct memory access unit (DMA) has ownership of a main bus.

According to an exemplary embodiment of the present invention, there is provided a system including a first master, a first local bus connected to a memory device, a bridge, and a main bus connected to a second master and a peripheral device. The bridge is connected among the first master, the memory device, and the main bus. The bridge functions as a wrapper and also serves to decode an address output from the first master, monitor a status of ownership of the main bus, and output a wait signal to the first master based on a decoding result and a monitoring result. Even while the second master is accessing the peripheral device via the main bus, the first master can access the memory device via the first local bus.

The system may further include a second local bus connected between the memory device and the main bus. The memory device may include a memory core storing predetermined data and a controller having an arbitration function. When the first master and the second master simultaneously access the memory core, the controller permits access to the memory core to a master having a higher priority between the first and second masters and outputs a wait signal to the other master.

The bridge outputs a wait signal to the first master attempting to access the peripheral device while the second master is accessing the peripheral device.

The first master may be a CPU and the second master may be a DMA. The memory core may include non-volatile cells, for example, flash memory cells or read-only memory (ROM) cells, or volatile memory cells, for example dynamic random access memory (DRAM) cells or static RAM (SRAM) cells.

According to an exemplary embodiment of the present invention, there is provided an access method including monitoring a status of ownership of a main bus using a bridge connected to a CPU, the main bus being connected to a peripheral device and a DMA, and a first memory device and a second memory device via a first local bus; decoding a first address output from the CPU using the bridge; and outputting a first wait signal to the CPU or outputting the first address output from the CPU to one among the peripheral device, the first memory device, and second memory device based on a monitoring result and a decoding result, using the bridge.

When the first memory device comprises a controller and a memory core storing predetermined data, the access method may further include receiving the first address input via the first local bus to access the memory core and a second address input via a second local bus from the DMA to access the memory core using the controller; comparing priority of the CPU with priority of the DMA based on the first address and the second address; and permitting the access to the memory core to one of the CPU and the DMA and outputting a wait signal to the other one of the CPU and the DMA.

### BRIEF DESCRIPTION OF THE DRAWINGS

Exemplary embodiments of the present invention will be understood in more detail from the following descriptions taken in conjunction with the accompanying drawings in which:

FIG. 1 is a block diagram of a conventional micro control unit (MCU) system including a flash memory device; and

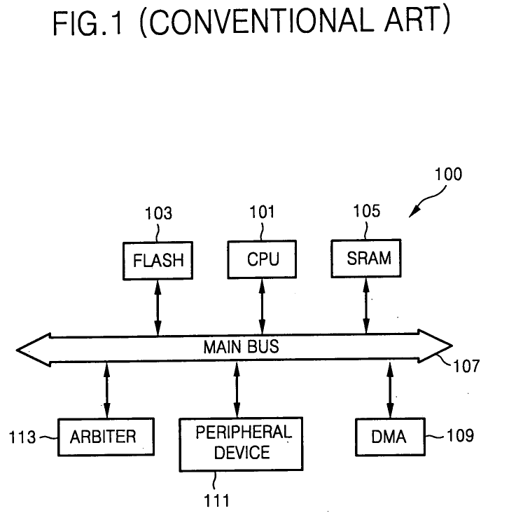

FIG. 2 is a block diagram of a system having a bus architecture for improving the performance of a central processing unit (CPU), according to an exemplary embodiment of the present invention.

### DETAILED DESCRIPTION OF EXEMPLARY EMBODIMENTS

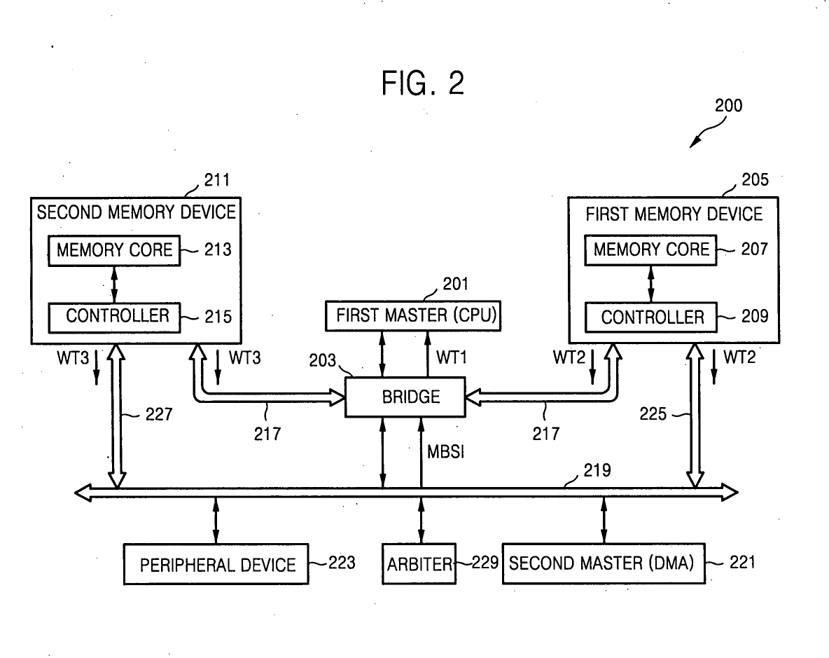

FIG. 2 is a block diagram of a system 200 having a bus architecture for improving the performance of a central processing unit (CPU), according to an exemplary embodiment of the present invention.

The system 200 may be used for image processing systems such as a camcorder, a computer, and a mobile phone with a camera, but the present invention is not restricted thereto.

Referring to FIG. 2, the system 200 includes a first master 201, a bridge 203, a first memory device 205, a second memory device 211, a first local bus 217, a main bus 219, a second master 221, a peripheral device 223, a second local bus 225, a third local bus 227, and an arbiter 229.

The first master 201 may be implemented by a CPU or a micro control unit (MCU). The first master 201 can transmit data to and receive data from any one among the first memory device 205, the second memory device 211, and the peripheral device 223 via the bridge 203.

The bridge 203 is connected to the first master 201, the first memory device 205, the second memory device 211, and the main bus 219. The bridge 203 functions as a wrapper, for example, CPU wrapper, and may also serve to decode an address output from the first master 201, for example, a CPU, monitor ownership of the main bus 219, and output a first wait signal WT1 to the first master 201 based on a decoding result and a monitoring result. The bridge 203 interprets the address output from the first master 201, for example, a CPU, and transmits the address to a device, for example, the first memory device 205, the second memory device 211, or the peripheral device 223, that the first master 201, that is, the CPU, wants to access.

The first memory device 205 includes a memory core 207 storing predetermined data and a controller 209. The memory core 207 may be implemented by a volatile memory such as a dynamic random access memory (DRAM) or SRAM, a non-volatile memory such as a flash memory or read-only memory (ROM), or a special function register (SFR). The present invention, however, is not restricted thereto.

When the first master 201 and the second master 221 simultaneously access the memory core 207 via the first local bus 217 and the second local bus 225, respectively, the controller 209 permits one of the first master 201 and the second master 221 to access the memory core 207 and outputs a second wait signal WT2 to the other one of the two masters 201 and 221 according to predetermined priority. The priority may be determined in terms of hardware, for example, a register, or software.

The second memory device 211 includes a memory core 213 storing predetermined data and a controller 215. The memory core 213 may be implemented by volatile memory such as DRAM or SRAM, non-volatile memory such as flash memory or ROM, or a special function register. The present invention, however, is not restricted thereto.

When the first master 201 and the second master 221 simultaneously access the memory core 213 via the first local bus 217 and the third local bus 227, respectively, the controller 215 permits one of the first master 201 and the second master 221 to access the memory core 213 and outputs a third wait signal WT3 to the other one of the two masters 201 and 221 according to the predetermined priority. The controller 215 functions as an arbiter to reduce time loss occurring due to the arbitration of the arbiter 229 on the main bus 219.

The first local bus 217 is connected between the bridge 203 and the first memory device 205 and between the bridge 203 and the second memory device 211. The main bus 219 may be implemented by an advanced high-performance bus (AHB), but the present invention is not restricted thereto. The second master 221 may be implemented by a direct memory access unit (DMA), but the present invention is not restricted thereto. The second master 221 can transmit data to and receive data from any one among the first memory device 205, the second memory device 211, and the peripheral device 223.

The peripheral device 223 may be any one among an input/output control circuit, a watch dog timer (WDT), an analog-to-digital converter (ADC), and a universal asynchronous receiver/transmitter (UART). The second master 221 and the peripheral device 223 are connected to the main bus 219. While the second master 221 has ownership of the main bus 219, the second master 221 transmits data to and receives data from the peripheral device 223 via the main bus 219. The second local bus 225 is connected between the first memory device 205 and the main bus 219. Accordingly, the second master 221 can transmit data to and receive data from the first memory device 205 via the main bus 219 and the second local bus 225.

The third local bus 227 is connected between the second memory device 211 and the main bus 219. Accordingly, the second master 221 can transmit data to and receive data from the second memory device 211 via the main bus 219 and the third local bus 227. In exemplary embodiments of the present invention, the first memory device 205 and the second memory device 211 may be connected to one of the second and third local bus 225 and 227.

The arbiter 229 arbitrates the ownership of the main bus 219 between the first master 201 and the second master 221 according to the predetermined priority. The predetermined priority may be round robin priority or fixed priority, which is well known to those skilled in the art.

A method by which at least one of the first master 201 and the second master 221 accesses a corresponding device or slave, that is, the first memory device 205, the second memory device 211, or the peripheral device 223, will be described with reference to FIG. 2 below.

In a first case where the first master 201 has the ownership of or has the right to control the main bus 219, the first master 201 can freely access the first memory device 205; the second memory device 211, or the peripheral device 223, and there is no deterioration of the performance of the system 200.

In a second case where the second master 221 has the ownership of the main bus 219 and the first master 201 accesses the first memory device 205 or the second memory device 211 via the first local bus 217, that is, the second master 221 accesses the peripheral device 223 connected to the main bus 219 and the first master 201 accesses one of the first memory device 205 and the second memory device 211, which are connected to the first local bus 217, the first master 201 performs the access to the first memory device 205 or the second memory device 211 with ownership of the first local bus 217 while the second master 221 performs the access to the peripheral device 223 with the ownership of the main bus 219.

In a third case where the second master 221 has the ownership of the main bus 219 and the first master 201 and the second master 221 simultaneously access the memory core 207 of the first memory device 205, the controller 209 having an arbitration function permits the access to the memory core 207 to one master, for example, the first master 201, having a higher priority between the first master 201 and the second master 221 and outputs the second wait signal WT2 to the other master, for example, the second master 221.

Accordingly, the second master 221 is held in a wait state in response to the second wait signal WT2 until the second wait signal WT2 is released. When the second master 221 accesses the memory core 207, the first master 201 is held in the wait state in response to the second wait signal WT2 until the second wait signal WT2 is released.

Since a delay due to the hold occurs only during the access to the first memory device 205 or the second memory device 211, a delay occurring due to the arbitration of the controller 209 or 215 is about half of the delay occurring due to the arbitration of the arbiter 229. When the second master 221 sequentially accesses the first memory device 205 and the peripheral device 223, if the arbiter 229 performs arbitration, the first master 201 cannot access the first memory device 205 even while the second master 221 accesses the peripheral device 223.

In the system 200 according to an exemplary embodiment of the present invention, however, when the second master 221 sequentially accesses the first memory device 205 and the peripheral device 223, the first master 201 can access the first memory device 205 via the first local bus 217 even while the second master 221 accesses the peripheral device 223 via the main bus 219. Accordingly, the performance of the system 200 is improved.

The function of the controller 215 included in the second memory device 211 is the same as that of the controller 209 included in the first memory device 205. Those skilled in the art will easily understand the function of the controller 215 included in the second memory device 211.

In a fourth case where the second master 221 has the ownership of the main bus 219 and the first master 201 outputs an address for accessing the peripheral device 223 to the bridge 203, the bridge 203 decodes the address and outputs the first wait signal WT1 to the first master 201 based on a decoding result and main bus status information (MBSI). The first master 201 is held in the wait state in response to the first wait signal WT1 until the first wait signal WT1 is released.

For example, when the second master 221 has the ownership of the main bus 219, the MBSI is activated to a high level, that is, a data value of “1”. Otherwise, the MBSI is deactivated to a low level, that is, a data value of “0”. Accordingly, the bridge 203 can recognize the status of the ownership of the main bus 219 based on the level of the MBSI.

As described above, according to an exemplary embodiment of the present invention, while a second master like a DMA has the ownership of a main bus, a first master like a CPU can access a memory device connected to a local bus without being held in a wait state.

In addition, when the second master has the ownership of the main bus and the first master and the second master simultaneously access the memory device, time loss can be reduced due to the arbitration of a controller included in the memory device. As a result, the present invention increases the performance of the first master like a CPU.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A system comprising:
a main bus connected to a peripheral device;
a first local bus connected to a memory device including a controller having an arbitration function and a memory core storing predetermined data;
a second local bus connected between the main bus and the memory device;
a first master capable of having an ownership of the main bus to access the peripheral device or an ownership of the first local bus to access the memory device;
a second master connected to the main bus and capable of having an ownership of the main bus to access the peripheral device or an ownership of the second local bus to access the memory device; and
a bridge connected to the main bus, the first master, and the memory device, the bridge monitoring whether the second master has the ownership of the main bus, decoding an address output from the first master, and outputting a first wait signal to the first master or outputting the address to one of the memory device and the peripheral device based on a monitoring result and a decoding result,
wherein, when the first master and the second master simultaneously access the memory core, the controller permits access to the memory core to one of the first master and the second master and outputs a second wait signal to the other one of the first master and the second master

2. The system of claim 1, wherein, when the first master and the second master simultaneously access the memory core, the controller permits access to the memory core to a master having a higher priority between the first master and the second master and outputs a second wait signal to a master having a lower priority between the first master and the second master.

3. The system of claim 1, wherein the first master is a central processing unit (CPU) and the second master is a direct memory access unit (DMA).

4. The system of claim 1, wherein the memory core comprises non-volatile memory cells.

5. The system of claim 1, wherein the memory core comprises volatile memory cells.

6. The system of claim 1, wherein the first master is held in a wait state in response to the first wait signal.

7. The system of claim 1, wherein the master having the lower priority is held in a wait state in response to the second wait signal.

8. The system of claim 1, wherein the system is an image processing system.

9. The system of claim 1, wherein the system is one of a camcorder, a mobile phone with a camera, and a computer.

10. An access method comprising:
monitoring a status of ownership of a main bus using a bridge connected to a central processing unit (CPU), the main bus connected to a peripheral device and a direct memory access unit (DMA), and a first memory device and a second memory device via a first local bus;
decoding a first address output from the CPU using the bridge; and
outputting a first wait signal to the CPU or outputting the first address output from the CPU to one of the peripheral device, the first memory device, and the second memory device based on a monitoring result and a decoding result, using the bridge.

11. The access method of claim 10, wherein the bridge outputs the first wait signal to the CPU while the DMA has the ownership of the main bus.

12. The access method of claim 10, wherein the first memory device is a non-volatile memory device and the second memory device is a volatile memory device.

13. The access method of claim 10, further comprising, when the first memory device comprises a controller and a memory core storing predetermined data:
receiving the first address input via the first local bus to access the memory core and a second address input via a second local bus from the DMA to access the memory core using the controller;
comparing a priority of the CPU with a priority of the DMA based on the first address and the second address; and
permitting access to the memory core to one of the CPU and the DMA and outputting a second wait signal to the other one of the CPU and the DMA.
